(19) United States
(12) Patent Application Publication
(10) Pub. No.: US 2014/0212730 A1
(43) Pub. Date: Jul. 31, 2014

(54) METHOD FOR SELECTING ELECTROCHEMICAL CELLS DURING THE PRODUCTION OF A BATTERY AND BATTERY COMPRISING ELECTROCHEMICAL CELLS

(71) Applicant: Tim Schaefer, Harztor (DE)

(72) Inventor: Tim Schaefer, Harztor (DE)

(73) Assignee: Li-Tec Battery GmbH, Kamenz (DE)

(21) Appl. No.: 14/117,709

(22) PCT Filed: May 2, 2012
(86) PCT No.: PCT/EP2012/001885

§ 371 Date: Dec. 20, 2013

(30) Foreign Application Priority Data
May 17, 2011 (DE) 10 2011 101 793.7

(51) Int. Cl. H01M 10/48; H01M 10/04

(52) U.S. Cl. CPC H01M 10/482; H01M 10/0413
USPC 429/149; 702/63

(57) ABSTRACT

The invention relates to a method for selecting electrochemical cells during the production of a battery that has a number of electrochemical cells, said method having the following steps: (S1) detecting the parameter data (D_{Par.}) of an individual cell that is to be analysed; (S2) transmitting the detected parameter data (D_{par.}) to a control unit; (S3) assigning the detected parameter data (D_{Par.}) to the electrochemical cell; and (S4) determining for the electrochemical cell that has been allocated the parameter data if a predefined relationship exists between the parameter data (D_{par.}) and predefined parameter values (W_{Par}, W_{par.1}, W_{Par.2}, W_{Par.3}. W_{Par 4}, W_{Par.5}) by means of the control unit. The method can further have the following steps: (S5a) feeding the electrochemical cell that has been assigned the parameter data (D_{Par.}) to a first production line for producing a first type of battery, if in step (S4) the existence of a predefined relationship has been determined; or (S5b) feeding the electrochemical cell that has been assigned the parameter data (D_{Par.}) to a second production line for producing a second type of battery, if in step (S4) the non-existence of a predefined relationship has been determined.

The invention relates to a method for selecting electrochemical cells during the production of a battery which comprises a plurality of electrochemical cells and a battery produced in accordance with the method.

Electrochemical energy stores, also referred to as electrochemical or galvanic cells in the following, are frequently manufactured in the form of stackable units, wherein batteries for various applications, particularly for use in electrically operated motor vehicles, can be produced by combining a plurality of such cells. The invention will be described with reference to its use in a motor vehicle, whereby it is however pointed out that such a method and battery with accordingly designed electrochemical cells can also be operated independently of motor vehicles, e.g. in stationary use.

The entire content of the DE 10 2011101793 priority application is fully incorporated as an integral part of the present application by reference herein.

Different methods for manufacturing a battery comprising a plurality of electrochemical cells are known from the prior art.

The present invention is based on the object of providing an improved method for selecting electrochemical cells during the production a battery which comprises a number of electrochemical cells and on a corresponding battery.

This object is accomplished by a method for selecting electrochemical cells during the production of a battery in accordance with claim 1 and by a battery in accordance with claim 13. The subclaims relate to advantageous further developments of the invention.

According to a first aspect, in a method for selecting electrochemical cells during the production of a battery which comprises a number of electrochemical cells, this object is accomplished by the method comprising the following steps: acquiring parameter data on an individual electrochemical cell to be analyzed in order to assess the quality of the electrochemical cell, feeding the acquired parameter data to a control unit, associating the electrochemical cell with the parameter data, and determining by means of the control unit whether there is a predetermined correlation between the parameter data for the electrochemical cell associated with said parameter data relative to predetermined parameter values. One advantage of this method is that from a cost, quality as well as design point of view relative a battery application to be selected, production yield can be increased. In particular, the electrochemical cells selected for the battery or the battery assembly can be of a selective predetermined quality. Thus, for example batteries having a first, preferably higher quality can be used for original equipment while batteries having a second, preferably normal quality can be used for the aftermarket. Furthermore, batteries of a third quality can be used for stationary application.

An electrochemical cell in the present context is to be understood as an electrochemical energy store; i.e. a device which stores energy in chemical form, releases the energy to a load in electrical form, and can preferably also absorb it in electrical form from a charging device. Galvanic cells and fuel cells are important examples of such electrochemical energy stores. The electrochemical cell comprises at least one first and one second device for storing electrically different charges as well as means for producing an operative electrical connection between said two devices, wherein charge carriers can be positioned between the two devices. A means for producing an operative electrical connection refers for example to an electrolyte acting as an ionic conductor.

Parameter data is to be understood in the present context not only as a plurality of parameter data, but also, where applicable, one single parameter datum. Accordingly, predetermined parameter values in the present context is not only to be understood as a plurality of predetermined parameter values, but also, where applicable, one single predetermined parameter value.

It has proven advantageous for the control unit determination step to comprise at least one of the following determining steps: determining whether the transmitted parameter data includes predetermined first parameter values and/or determining whether the transmitted parameter data does not include predetermined second parameter values.

Preferably, the control unit determination step comprises at least one of the following determining steps: determining whether the transmitted parameter data exceeds predetermined third parameter values and/or determining whether the transmitted parameter data falls short of predetermined fourth parameter values.

The method can furthermore comprise at least one of the supply steps: feeding the electrochemical cell associated with the parameter data to a first production line for producing first battery types when the predetermined correlation is determined in the determination step or feeding the electrochemical cell associated with the parameter data to a second production line for producing second battery types when the predetermined correlation is not determined in the determination step.

The control unit determination step can additionally comprise the step: determining whether the parameter data is within at least one predetermined parameter value range for a predetermined fifth parameter value.

A first parameter value range of 1.2%, preferably 0.6%, has proven advantageous in the method for the feeding to a first production line for producing hybrid cell batteries.

A second parameter value range of 3%, preferably 1.5%, has proven further advantageous for the feeding to a second production line for producing plug-in hybrid batteries, wherein preferably the parameter data of the electrochemical cells to be fed to the second production line is beyond, in particular outside of the preferred parameter range of the aforementioned first embodiment.

A third parameter value range of 4.5%, preferably 2.2%, has proven further advantageous for the feeding to a third production line for producing electric vehicle or device batteries, wherein preferably the parameter data of the electrochemical cells to be fed to the third production line is beyond, in particular outside of the preferred parameter range of the aforementioned first embodiment and/or preferably the parameter data of the electrochemical cells to be fed to the third production line is beyond, in particular outside of the preferred parameter range of the aforementioned second embodiment.

A fourth parameter value range of 50%, preferably 25%, has proven further advantageous for the feeding to a fourth production line for producing batteries for stationary applications, wherein preferably the parameter data of the electrochemical cells to be fed to the fourth production line is beyond, in particular outside of the preferred parameter range of the aforementioned first embodiment and/or preferably the parameter data of the electrochemical cells to be fed to the fourth production line is beyond, in particular outside of the preferred parameter range of the aforementioned second embodiment and/or preferably the parameter data of the electrochemical cells to be fed to the fourth production line is beyond, in particular outside of the preferred parameter range of the aforementioned third embodiment.

It is preferential for at least one electrochemical cell parameter data to be selected from a parameter group comprising at least one of the following parameters: the open-circuit voltage of the electrochemical cell, the capacitance of the electrochemical cell, the internal resistance of the electrochemical cell, a change in the internal resistance of the electrochemical cell after application of a pressure, preferably to side surfaces of the electrochemical cell, or the internal pressure of the electrochemical cell. It is particularly preferential to use as parameter data the internal resistance of the electrochemical cell during or after finishing upon in particular application of a pressure via the side surfaces of the electrochemical cell, whereby preferably at least three or more resistances are used. The change in the internal resistance of the electrochemical cell after application of a pressure to the electrochemical cell's side surfaces has proven to be a preferential parameter for assessing the quality of an electrochemical cell. When pressure is applied to an electrochemical cell and the electrochemical cell yields, the internal resistance changes. Hence, a pressure can be applied to the electrochemical cell and the change in internal resistance measured. Electrochemical cells which are relatively hard and which have minimal internal resistance change after application of pressure to their side surfaces no longer outgas once closed. The change in the internal resistance relative to the change in pressure can thus allow a particularly simple correlating of the electrochemical cell to different types of quality and thus to appropriate production lines. Hence, the quality can for example be expressed by the following relationship in which dRᵢ denotes the change in the internal resistance and dF denotes the change in applied pressure:

$$\frac{d {R}_{i}}{d F} \approx quality parameter$$

According to a second aspect, the object is accomplished by a battery which comprises a plurality of electrochemical cells by the battery being produced in accordance with one of the above-cited production methods.

It has proven advantageous for the battery to be designed as a battery selected from a battery group which comprises: plug-in hybrid batteries, hybrid cell batteries, electric vehicle batteries, device batteries or batteries for stationary applications.

Moreover, the electrochemical cell of the battery can additionally comprise a storage apparatus designed to store a quality value.

The present invention further relates to a battery having electrochemical cells which is designed for use in a motor vehicle.

The following will draw on preferred embodiments as well as the figures in describing advantages of the invention in greater detail. Shown are:

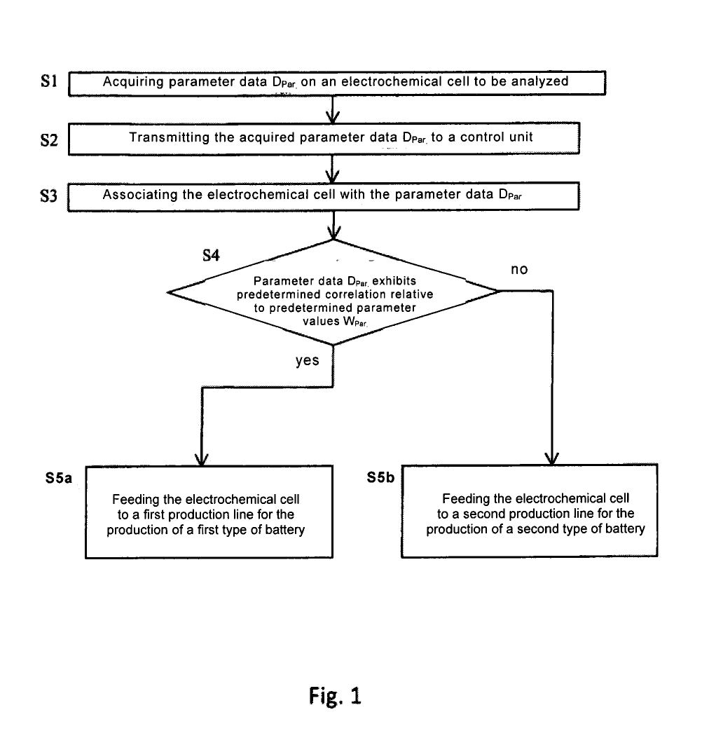

FIG. 1 a flow chart for an inventive method of selecting electrochemical cells during the production of a battery according to a first embodiment,

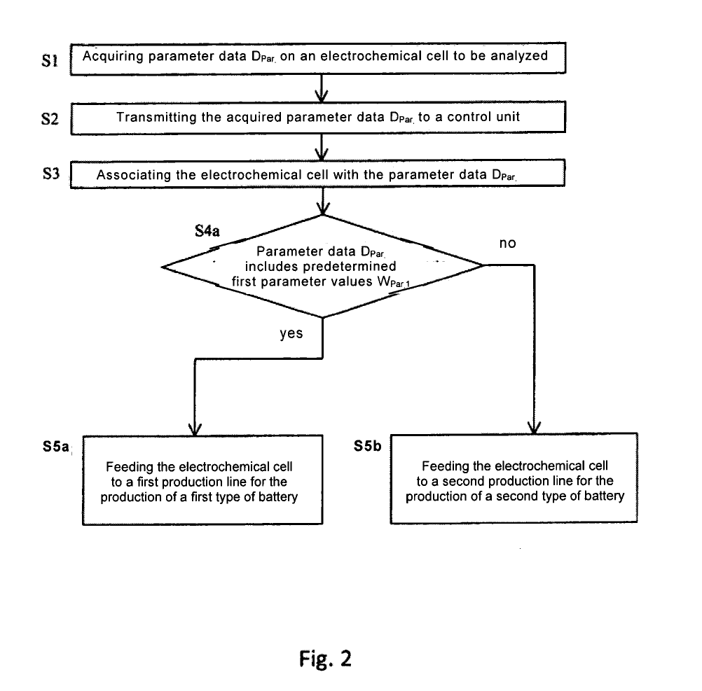

FIG. 2 a flow chart for an inventive method of selecting electrochemical cells during the production of a battery according to a second embodiment,

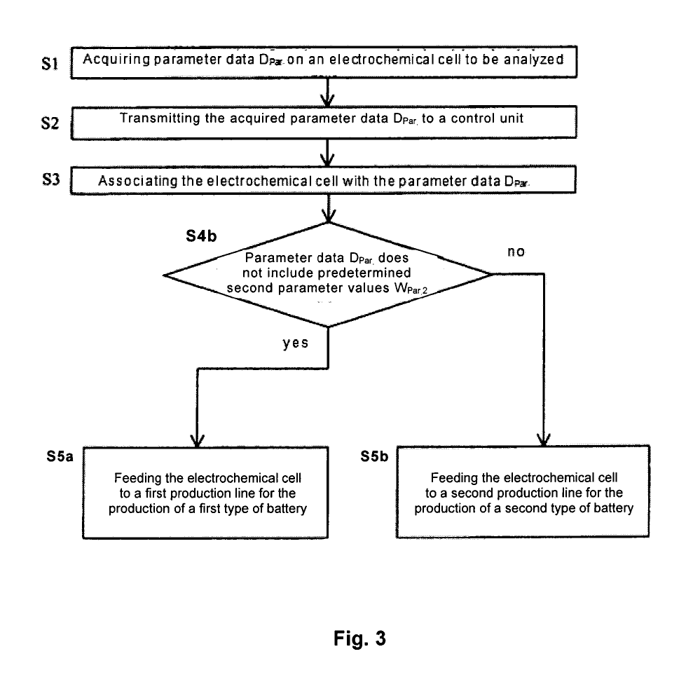

FIG. 3 a flow chart for an inventive method of selecting electrochemical cells during the production of a battery according to a third embodiment,

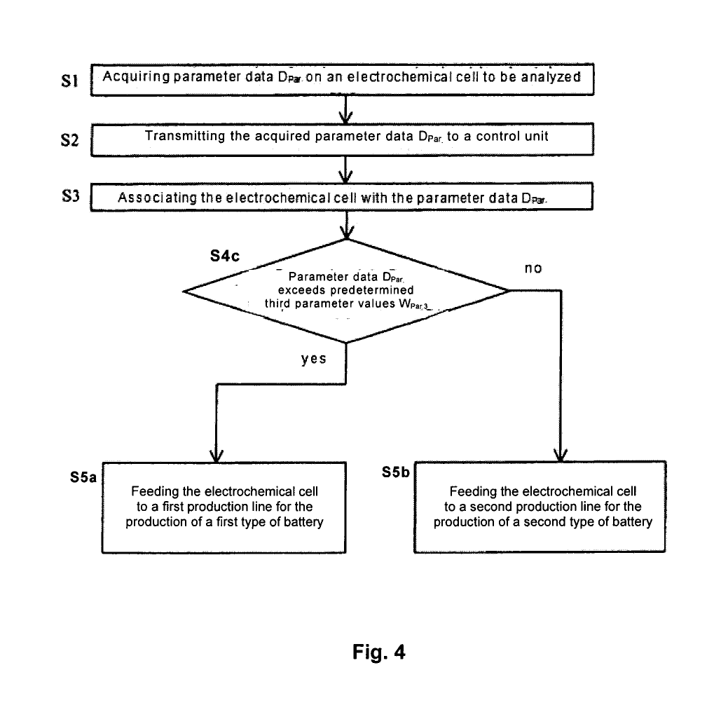

FIG. 4 a flow chart for an inventive method of selecting electrochemical cells during the production of a battery according to a fourth embodiment,

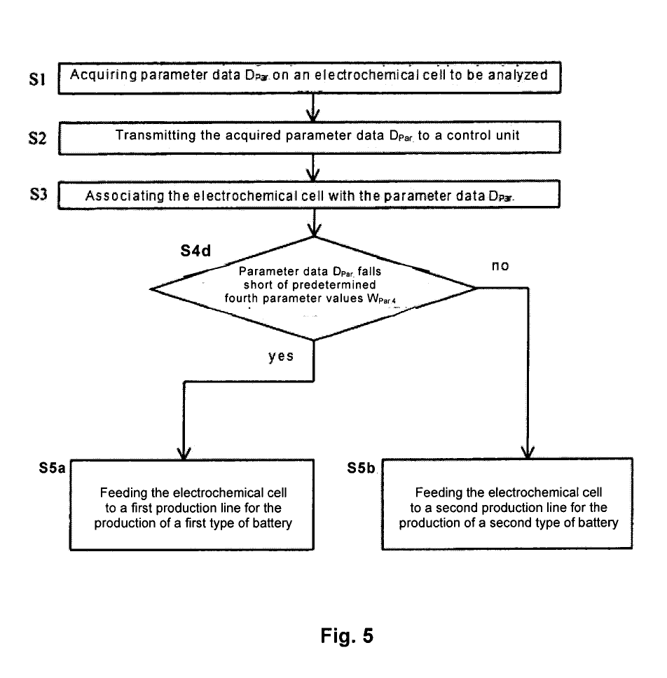

FIG. 5 a flow chart for an inventive method of selecting electrochemical cells during the production of a battery according to a fifth embodiment,

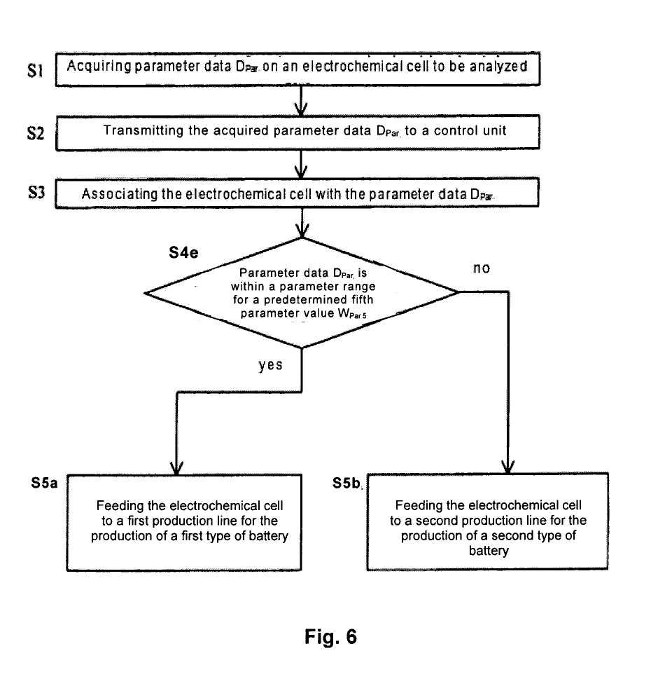

FIG. 6 a flow chart for an inventive method of producing a battery in accordance with a sixth embodiment, and

FIG. 7 a flow chart for a modification of the inventive method of selecting electrochemical cells during the production of a battery.

FIG. 1 shows a flow chart for an inventive method of selecting electrochemical cells during the production of a battery according to a first embodiment. In step S1, parameter data D_{Par.} on an electrochemical cell to be evaluated is acquired. In step S2, the parameter data D_{Par.} is fed to a control unit and in step S3, said parameter data D_{Par.} is associated with the electrochemical cell. It is determined by means of the control unit whether this parameter data D_{Par.} has a predetermined correlation relative to predetermined parameter values W_{Par.}. Should the parameter data D_{Par.} have the predetermined correlation relative to the predetermined parameter values W_{Par.1}, the electrochemical cell will be fed to a first production line for producing a first type of battery. Otherwise, when the parameter data D_{Par.} does not have the predetermined correlation relative to the predetermined parameter values W_{Par.1}, the electrochemical cell will be fed to a second production line for producing a second type of battery.

FIG. 2 shows a flow chart for an inventive method of selecting electrochemical cells during the production of a battery according to a second embodiment, its steps S1 to S3 corresponding to the first embodiment to which reference is made to avoid repetition.

It is determined by means of the control unit whether said parameter data D_{Par.} exhibits predetermined first parameter values W_{Par.1}. Should the parameter data D_{Par.} exhibit the predetermined first parameter values W_{Par.1}, the electrochemical cell will be fed to a first production line for producing a first type of battery. Otherwise, if the parameter data D_{Par.} does not exhibit the predetermined first parameter values W_{Par.1}, the electrochemical cell will be fed to a second production line for producing a second type of battery.

FIG. 3 shows a flow chart for an inventive method of selecting electrochemical cells during the production of a battery according to a third embodiment, its steps S1 to S3 corresponding to the first embodiment to which reference is made to avoid repetition.

It is determined by means of the control unit if said parameter data D_{Par.} does not include predetermined second parameter values W_{Par.2}. Should the parameter data D_{Par.} not exhibit the predetermined second parameter values W_{Par.2}, the electrochemical cell will be fed to a first production line for producing a first type of battery. Otherwise, when the parameter data

Dₚₐᵣ does exhibit the predetermined second parameter values W_{Par.2}, the electrochemical cell will be fed to a second production line for producing a second type of battery.

FIG. 4 shows a flow chart for an inventive method of selecting electrochemical cells during the production of a battery according to a fourth embodiment, its steps S1 to S3 corresponding to the first embodiment to which reference is made to avoid repetition.

It is determined by means of the control unit whether said parameter data D_{Par.} exceeds the predetermined third parameter values W_{Par.3}. Should the parameter data D_{Par.} exceed the predetermined third parameter values W_{Par.3}, the electrochemical cell will be fed to a first production line for producing a first type of battery. Otherwise, when the parameter data D_{Par.} does not exceed the predetermined third parameter values W_{Par.3}, the electrochemical cell will be fed to a second production line for producing a second type of battery.

FIG. 5 shows a flow chart for an inventive method of selecting electrochemical cells during the production of a battery according to a fifth embodiment, its steps S1 to S3 corresponding to the first embodiment to which reference is made to avoid repetition.

It is determined by means of the control unit if said parameter data D_{Par.} does not exceed predetermined fourth parameter values W_{Par.4}. Should the parameter data D_{Par.} fall short of the predetermined fourth parameter values W_{Par.4}, the electrochemical cell will be fed to a first production line for producing a first type of battery. Otherwise, when the parameter data Dₚₐᵣ does not fall short of the predetermined fourth parameter values W_{Par.4}, the electrochemical cell will be fed to a second production line for producing a second type of battery.

FIG. 6 shows a flow chart for an inventive method of selecting electrochemical cells during the production of a battery according to a sixth embodiment, its steps S1 to S3 corresponding to the first embodiment to which reference is made to avoid repetition.

It is determined by means of the control unit whether said parameter data D_{Par.} falls within a predetermined parameter range for a predetermined fifth parameter value W_{Par.5}. Should the parameter data D_{Par.} be within the predetermined parameter range for the predetermined fifth parameter value W_{Par.5}, the electrochemical cell will be fed to a first production line for producing a first type of battery. Otherwise, when the parameter data D_{Par.} does not lie within the predetermined parameter range for the predetermined fifth parameter value W_{Par.5}, the electrochemical cell will be fed to a second production line for producing a second type of battery.

FIG. 7 shows a flow chart for modification of the above-cited inventive method for selecting electrochemical cells during the production of a battery, its steps S1 to S3 corresponding to those of the first embodiment to which reference is made to avoid repetition, and which can be combined with any of the first to sixth embodiments.

This modification has the additional step S4.1 and S4.2 after step S3. In step S4.1, a quality value is established by means of parameter data D_{Par.} which is stored in step S4.2 in a storage unit arranged in or on the electrochemical storage cell. The quality value can for example be used for a classification of the electrochemical cell which can for example be used for subsequent production steps or when analyzing the battery.

The present invention further relates to a battery comprising said electrochemical cells, particularly a battery designed for use in a motor vehicle which comprises said electrochemical cells.

### LIST OF REFERENCE NUMERALS

D_{Par.} parameter data
W_{Par.} predetermined parameter value
W_{Par.1} first predetermined parameter value
W_{Par.2} second predetermined parameter value
W_{Par.3} third predetermined parameter value
W_{Par.4} fourth predetermined parameter value
W_{Par.5} fifth predetermined parameter value
S1 Acquiring parameter data on the electrochemical cell
S2 Transmitting the acquired parameter data to a control unit
S3 Associating the electrochemical cell with the parameter data
S4 Determining via the control unit whether there is a predetermined correlation of the parameter data relative to predetermined parameter values
S4.1 Establishing at least one quality value by means of the parameter data
S4.2 Storing the quality value in a storage unit arranged in or on the electrochemical storage cell
S4a Determining whether the transmitted parameter data includes predetermined first parameter values
S4b Determining whether the transmitted parameter data does not include predetermined second parameter values
S4c Determining whether the transmitted parameter data exceeds predetermined third parameter values
S4d Determining whether the transmitted parameter data falls short of predetermined fourth parameter values
S4e Determining whether the transmitted parameter data is within a predetermined parameter value range for a predetermined fifth parameter value
S5a Feeding the electrochemical cell to a first production line for the production of a first type of battery when the presence of the predetermined correlation has been determined
S5b Feeding the electrochemical cell to a second production line for the production of a second type of battery in the absence of the predetermined correlation being determined

1. A method for selecting electrochemical cells during the production of a battery which comprises a plurality of electrochemical cells, comprising:
acquiring parameter data on an individual electrochemical cell to be analyzed to assess the quality of the electrochemical cell, wherein the step of acquiring the parameter data includes detecting changes in the internal resistance of the electrochemical cell related to changes in a pressure applied to side surfaces of the electrochemical cell;
transmitting the parameter data to a control unit;
associating the parameter data with the electrochemical cell; and
determining, by the control unit whether there is a predetermined correlation between the parameter data for the electrochemical cell associated with said parameter data relative to predetermined parameter values.

2. The method according to claim 1, wherein the associating of the parameter data includes storing the parameter data on the electrochemical cell.

3. The method according to claim 1, wherein the determining step comprises at least one of:
determining whether the transmitted parameter data exceeds predetermined third parameter values, or
determining whether the transmitted parameter data falls short of predetermined fourth parameter values.

4. The method according to claim 1, further comprising:
feeding the electrochemical cell associated with the parameter data to a first production line for the production of a first type of battery when the presence of the predetermined correlation has been determined in the determining step, or
feeding the electrochemical cell associated with the parameter data to a second production line for the production of a second type of battery in the absence of the predetermined correlation being determined in the determining step.

5. The method according to claim 4, wherein the determining step includes:
determining whether the transmitted parameter data is within a predetermined parameter value range for a predetermined fifth parameter value.

6. The method according to claim 5, wherein a first parameter value range for feeding to a first production line for producing hybrid cell batteries amounts to 1.2%.

7. The method according to claim 5, wherein a second parameter value range for feeding to a second production line for producing plug-in hybrid batteries amounts to 3% wherein the parameter data of the electrochemical cells to be fed to the second production line is beyond the first parameter range.

8. The method according to claim 5, wherein a third parameter value range for feeding to a third production line for producing electric vehicle batteries or device batteries amounts to 4.5% wherein the parameter data of the electrochemical cells to be fed to the third production line is beyond the first parameter range, and/or the parameter data of the electrochemical cells to be fed to the third production line is beyond the second parameter range.

9. The method according to claim 6, wherein a fourth parameter value range for feeding to a fourth production line for producing batteries for stationary applications amounts to 50% wherein the parameter data of the electrochemical cells to be fed to the fourth production line is beyond the first parameter range, and/or the parameter data of the electrochemical cells to be fed to the fourth production line is beyond the second parameter range, and/or the parameter data of the electrochemical cells to be fed to the fourth production line is beyond the third parameter range.

10. The method according claim 1, wherein at least one electrochemical cell parameter data is at least one of:
an open-circuit voltage of the electrochemical cell,
a capacitance of the electrochemical cell,
an internal resistance of the electrochemical cell,
a change in the internal resistance of the electrochemical cell after application of a pressure, or
an internal pressure of the electrochemical cell.

11. The method according to claim 1, further comprising:
establishing at least one quality value by means of the parameter data.

12. The method according to claim 11, further comprising:
storing the quality value in a storage unit arranged in or on the electrochemical cell which comprises a permanent memory.

13. A battery comprising a plurality of electrochemical cells, characterized in that the battery is produced according to claim 1.

14. The battery according to claim 13, wherein the battery is designed as at least one of:
a plug-in hybrid batteries,
a hybrid cell batteries,
an electric vehicle batteries,
a device batteries, or
a battery for stationary applications.

15. The method according to claim 1, wherein the determining step includes at least one of:
determining whether the transmitted parameter data includes predetermined first parameter values,
determining whether the transmitted parameter data does not include predetermined second parameter values.
